(19) United States
(12) Patent Application Publication
(10) Pub. No.: US 2023/0064722 A1
(43) Pub. Date: Mar. 2, 2023

(54) DYNAMIC TETHERING MECHANISM FOR POWER SAVING

(71) Applicant: MEDIATEK INC., Hsin-Chu (TW)

(72) Inventors: Sheng-Kai Chang, Hsinchu City (TW); Wang-Hsin Kuo, Hsinchu City (TW)

(73) Assignee: MEDIATEK INC., Hsin-Chu (TW)

(21) Appl. No.: 17/869,749

(22) Filed: Jul. 20, 2022

Related U.S. Application Data
(60) Provisional application No. 63/236,712, filed on Aug. 25, 2021.
(60) Provisional application No. 63/243,236, filed on Sep. 13, 2021.

(51) Int. Cl. H04W 48/16

(52) U.S. Cl. CPC H04W 48/16

(57) ABSTRACT

The present invention provides a control method of a tethering device, wherein the control method includes the steps of: receiving cellular information of the tethering device, and determining a first tethering mode according to the cellular information; and using the first tethering mode to configure at least one interface of the tethering device, wherein the at least one interface of the tethering device is used to communicate with an electronic device, and the electronic device shares a cellular network of the tethering device via the at least one interface.

### CROSS REFERENCE TO RELATED APPLICATIONS

This application claims the benefit of U.S. Provisional Application No. 63/236,712, filed on Aug. 25, 2021. Further, this application claims the benefit of U.S. Provisional Application No. 63/243,236, filed on Sep. 13, 2021. The contents of these applications are incorporated herein by reference.

### BACKGROUND

Tethering is the sharing of a mobile device's Internet connection with other connected devices, and the connection of a mobile device with other devices can be done over wireless LAN (Wi-Fi) , over Bluetooth or by physical connection using an Universal Serial Bus (USB) cable. The tethering such as the Wi-Fi tethering (i.e., sharing the Internet connection of a mobile device via its Wi-Fi interface) is a useful functionality and is widely supported on the mobile device, but existing Wi-Fi tethering schemes consume excessive power. For example, if the allowed Wi-Fi tethering bandwidth is greater than a cellular capacity of the module device, the actual bandwidth will always be limited by the cellular capacity, causing dummy power consumption of the Wi-Fi interface.

### SUMMARY

It is therefore an objective of the present invention to provide a tethering device, which can adjust the tethering modes according to the cellular capacity, to solve the above-mentioned problems.

According to one embodiment of the present invention, a controller of a tethering device is disclosed. The controller comprises a power manager and a tethering manager, wherein the power manager is configured to receive cellular information of the tethering device, and determine a first tethering mode according to the cellular information; and the tethering manager is configured to use the first tethering mode to configure at least one interface of the tethering device, wherein the at least one interface of the tethering device is used to communicate with an electronic device, and the electronic device shares a cellular network of the tethering device via the at least one interface.

According to one embodiment of the present invention, a control method of a tethering device comprises the steps of: receiving cellular information of the tethering device, and determining a first tethering mode according to the cellular information; and using the first tethering mode to configure at least one interface of the tethering device, wherein the at least one interface of the tethering device is used to communicate with an electronic device, and the electronic device shares a cellular network of the tethering device via the at least one interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a tethering device according to one embodiment of the present invention.

FIG. 2 is a diagram illustrating Wi-Fi configuration of the tethering mode according to one embodiment of the present invention.

FIG. 3 is a diagram illustrating USB configuration of the tethering mode according to one embodiment of the present invention.

FIG. 4 is a diagram illustrating Ethernet configuration of the tethering mode according to one embodiment of the present invention.

FIG. 5 is a flowchart of a control method of the tethering device according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

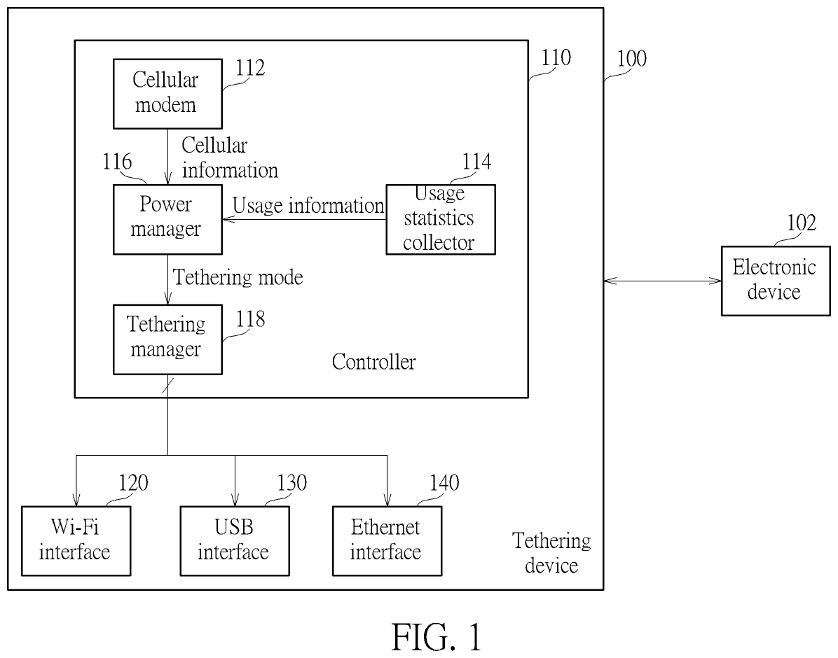

FIG. 1 is a diagram illustrating a tethering device 100 according to one embodiment of the present invention. As shown in FIG. 1, the tethering device 100 comprises a controller 110 and at least one network interface, wherein the controller 110 comprises a cellular modulator-demodulator (modem) 112, a usage statistics collector 114, a power manager 116 and a tethering manager 118, and the at least one network interface comprises a W-Fi interface 120, an USB interface 130 and an Ethernet interface 140. In this embodiment, the tethering device 100 can be a customer premises equipment (CPE) such as a router, a network switch or a cellular phone; and one or more electronic device, such as an electronic device 102 shown in FIG. 1, can connect to the tethering device 100 via one of the W-Fi interface 120, the USB interface 130 and the Ethernet interface 140, and the electronic device 102 can have the network via a broadband cellular network technology of the tethering device 100 such as a fourth generation of broadband cellular network technology (hereinafter, 4G) system or a fifth generation of broadband cellular network technology (hereinafter, 5G) system. In addition, the controller 110 can be implemented by using circuitry within one chip or more chips.

As described in the background of the invention, if the allowed Wi-Fi tethering bandwidth is greater than a cellular capacity of the module device, the actual bandwidth will always be limited by the cellular capacity, causing dummy power consumption of the Wi-Fi interface. In order to solve this problem, the controller 110 is designed to determine an appropriate tethering mode for the Wi-Fi, USB and/or Ethernet connections based on the current cellular capacity and/or usage statistics of the tethering device 100. Specifically, the power manager 116 of the controller 110 receives cellular information and usage information from the cellular modem 112 and the usage statistics collector 114, respectively, wherein the cellular information may comprise a radio access technology (RAT), such as 4G system or 5G system, currently used by the tethering device 100, a band currently used by the tethering device 100, and/or a real network speed of the tethering device 100; and the usage information may comprise network usage statistics indicating the flow of signal transmission/reception, for example, the usage information indicates if the flow of signal transmission/reception is steady or burst on the time axis, wherein the steady flow may indicate that the tethering device 100 is downloading files, and the flow having burst may indicate that the user is browsing the web.

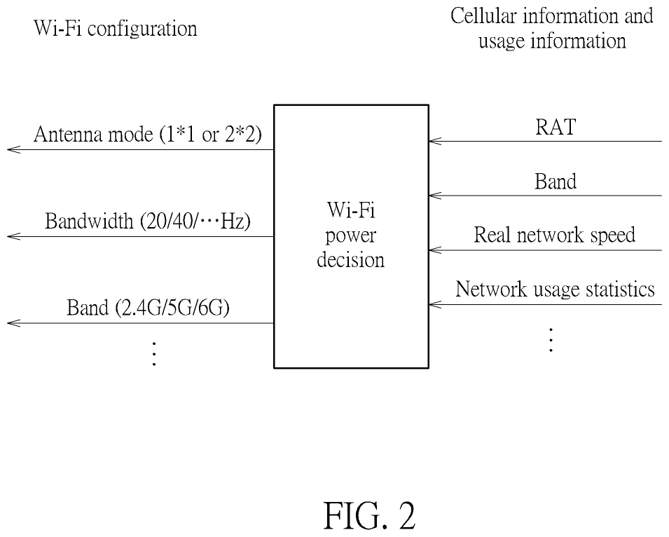

After obtaining the cellular information and the usage information, the power manager 116 determines a suitable tethering mode for at least one of the W-Fi interface 120, the USB interface 130 and the Ethernet interface 140. Taking FIG. 2 as an example, if the electronic device 102 is using the cellular network of the tethering device 100 via the Wi-Fi interface 120, the power manager 116 may refer to the RAT, band, real network speed, network usage statistics, and/or other cellular information and the usage information to determine an antenna mode (e.g., 1*1 antenna or 2*2 antenna), a bandwidth (channel width) (e.g., 20 Hz, 40 Hz, . . . ) or a band (e.g., 2.4GHz, 5GHz, 6 GHz) for the Wi-Fi interface 120. For example, if the cellular modem 112 of tethering device 100 operates the 5G system with higher cellular capacity, the power manager 116 may determine the tethering mode with 2*2 antenna configuration; and if the cellular modem 112 of tethering device 100 operates the 4G system with lower cellular capacity, the power manager 116 may determine the tethering mode with 1*1 antenna configuration. In one embodiment, the power manager 116 may refer to a look-up table to determine the suitable tethering mode, wherein the look-up records many combinations of the Wi-Fi configurations (e.g., antenna mode and band) and corresponding Wi-Fi bandwidth and power consumption. The power manager 116 can determine the suitable tethering mode by selecting one combination whose corresponding Wi-Fi bandwidth is closest to the cellular bandwidth of the tethering device 100, or selecting one combination whose corresponding Wi-Fi bandwidth is lower than the cellular bandwidth of the tethering device 100, wherein the cellular bandwidth can be a default value or an allowable maximum bandwidth corresponding to the current cellular information. Then, the power manager 116 controls the tethering manager 118 to use the tethering mode of the Wi-Fi interface 120.

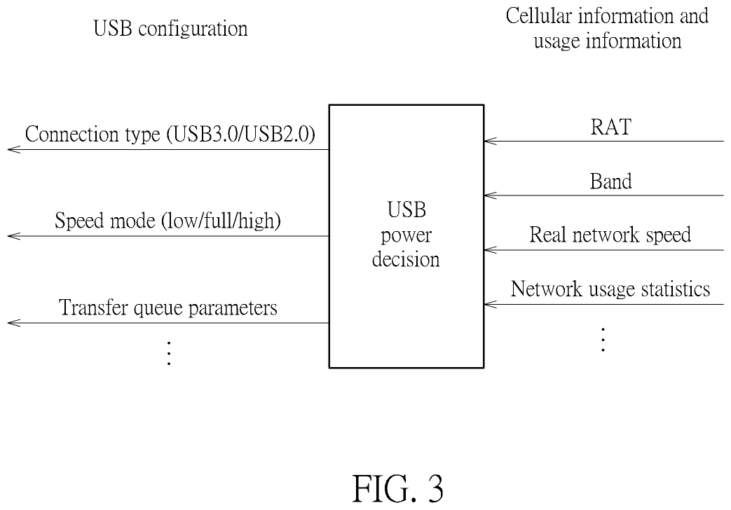

In the embodiment shown in FIG. 3, if the electronic device 102 is using the network of the tethering device 100 via the USB interface 130, the power manager 116 may refer to the RAT, band, real network speed, network usage statistics, and/or other cellular information and the usage information to determine a connection type (e.g., USB 2.0 or USB 3.0), a speed mode (e.g., low speed, full speed or high speed), or transfer queue parameters (e.g., length/number/priority) for the USB interface 130. For example, if the cellular modem 112 of tethering device 100 operates the 5G system with higher cellular capacity, the power manager 116 may determine the tethering mode with USB 3.0 connection type and high speed; and if the cellular modem 112 of tethering device 100 operates the 4G system with lower cellular capacity, the power manager 116 may determine the tethering mode with USB 2.0 connection type and low speed. In one embodiment, the power manager 116 may refer to a look-up table to determine the suitable tethering mode, wherein the look-up records many combinations of the USB configurations (e.g., USB type and speed mode) and corresponding USB bandwidth and power consumption. The power manager 116 can determine the suitable tethering mode by selecting one combination whose corresponding USB bandwidth is closest to the cellular bandwidth of the tethering device 100, or selecting one combination whose corresponding USB bandwidth is lower than the cellular bandwidth of the tethering device 100. Then, the power manager 116 controls the tethering manager 118 to use the tethering mode of the USB interface 130.

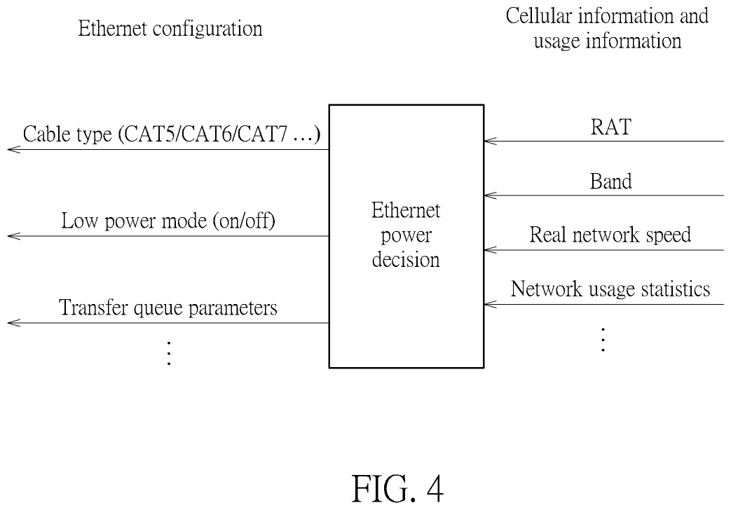

In the embodiment shown in FIG. 4, if the electronic device 102 is using the network of the tethering device 100 via the Ethernet interface 140, the power manager 116 may refer to the RAT, band, real network speed, network usage statistics, and/or other cellular information and the usage information to determine a cable type (e.g., CAT5/CAT6/CAT7 . . . ), transfer queue parameters (e.g., length/number/priority), and/or if operating in a low power mode for the Ethernet interface 140. For example, if the cellular modem 112 of tethering device 100 operates the 5G system with higher cellular capacity, the power manager 116 may determine the tethering mode with no low power mode; and if the cellular modem 112 of tethering device 100 operates the 4G system with lower cellular capacity, the power manager 116 may determine the tethering mode with low power mode. In one embodiment, the power manager 116 may refer to a look-up table to determine the suitable tethering mode, wherein the look-up records many combinations of the Ethernet configurations (e.g., cable type or low power mode) and corresponding Ethernet bandwidth and power consumption. The power manager 116 can determine the suitable tethering mode by selecting one combination whose corresponding Ethernet bandwidth is closest to the cellular bandwidth of the tethering device 100, or selecting one combination whose corresponding Ethernet bandwidth is lower than the cellular bandwidth of the tethering device 100. Then, the power manager 116 controls the tethering manager 118 to use the tethering mode of the Ethernet interface 140.

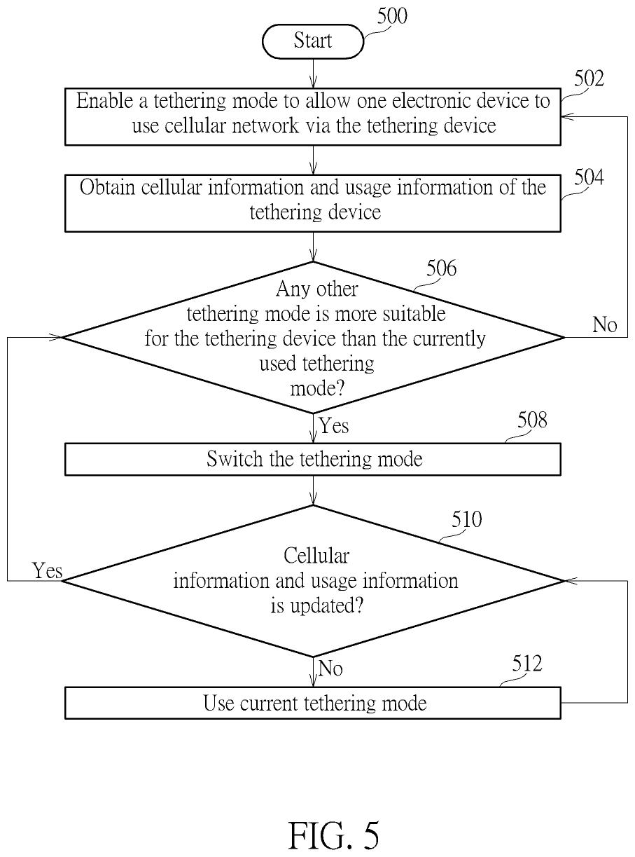

FIG. 5 is a flowchart of a control method of the tethering device 100 according to one embodiment of the present invention. In Step 500, the flow starts, and the tethering device 100 is powered on. In Step 502, the tethering device 100 enables a default tethering mode to allow the electronic device 102 to use the cellular network via the tethering device 100. In Step 504, the power manager 116 receives the cellular information and the usage information from the cellular modem 112 and the usage statistics collector 114, respectively, wherein the cellular information may comprise a RAT currently used by the tethering device 100, a band currently used by the tethering device 100, and/or a real network speed of the tethering device 100; and the usage information may comprise a network usage statistics indicating the flow of signal transmission/reception. In Step 506, the power manager 116 determines whether any other tethering mode is more suitable for the tethering device 100 than the currently used tethering mode, and the power manager 116 further determines whether the tethering device 100 is currently suitable for switching the tethering mode, if yes, the flow enters Step 508; and if not, the flow goes back to Step 502. In this embodiment, if the power manager 116 determines that the tethering device 100 is downloading files based on the usage information, the power manager 116 can select the tethering mode that will not cause network interruption to switch (e.g., the tethering mode needed to change the antenna mode is not suitable), and the Wi-Fi/USB/Ethernet bandwidth of the selected tethering mode is lower than or closest to the current cellular bandwidth of the tethering device 100. In addition, if the power manager 116 determines that the tethering device 100 is browsing web based on the usage information, the power manager 116 can directly select one tethering mode whose Wi-Fi/USB/Ethernet bandwidth is lower than or closest to the current cellular bandwidth of the tethering device, if any.

In Step 508, if the power manager 116 determines a new tethering mode that is more suitable than the current tethering mode in Step 506, the power manager 116 controls the tethering manager 118 to change the tethering mode of the Wi-Fi interface 120, the USB interface 130 or the Ethernet interface 140 by using the new tethering mode.

In Step 510, the power manager 116 continues to receive the cellular information and the usage information from the cellular modem 112 and the usage statistics collector 114, and determines if one of the cellular information and the usage information changes or updates, if yes, the flow goes back to Step 506 to determine if any other the tethering mode is more suitable; and if not, the flow enters Step 512 to use the current tethering mode . In this embodiment, since the tethering device 100 may enter the area that only supports lower bandwidth (e.g., without 5G service) as the user moves, and the user may change the usage of the tethering device 100, so the power manager 116 can dynamically determine the most suitable tethering mode to optimize the operations of the tethering device 100.

In one embodiment, the usage information may further comprise a distance between the electronic device 102 and the tethering device 100, and the tethering mode can be changed according to the distance. For example, if the tethering device 100 is using the Wi-Fi interface 120 with 2.4 GHz band to communicate with the electronic device 102 and the user takes the electronic device 102 close to the tethering device 100, the tethering device 100 can detect that the distance between the electronic device 102 and the tethering device 100 is getting closer, and the power manager 116 can use a new tethering mode to switch to 5 GHz band from to 2.4 GHz band to communicate with the electronic device 102

Briefly summarized, in the present invention, the tethering device can dynamically determine a suitable tethering mode according to the current cellular information and usage information of the tethering device, so that the allowed Wi-Fi/USB/Ethernet bandwidth between the tethering device and another electronic device will be closer to the cellular bandwidth, to improve the power consumption of the tethering device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller of a tethering device, comprising:
a power manager, configured to receive cellular information of the tethering device, and determine a first tethering mode according to the cellular information; and
a tethering manager, configured to use the first tethering mode to configure at least one interface of the tethering device, wherein the at least one interface of the tethering device is used to communicate with an electronic device, and the electronic device shares a cellular network of the tethering device via the at least one interface.

2. The controller of claim 1, wherein the cellular information comprises a radio access technology (RAT) currently used by the tethering device, a band currently used by the tethering device, and/or a real network speed of the tethering device.

3. The controller of claim 1, wherein the interface of the tethering device is a Wi-Fi interface, and the power manager refers to the cellular information to select the first tethering mode from a plurality of tethering modes, wherein the plurality of tethering modes comprise different combinations of antenna modes, bandwidths, and/or bands for the Wi-Fi interface.

4. The controller of claim 1, wherein the interface of the tethering device is an Universal Serial Bus (USB) interface, and the power manager refers to the cellular information to select the first tethering mode from a plurality of tethering modes, wherein the plurality of tethering modes comprise different combinations of connection types, speed modes, and/or transfer queue parameters for the USB interface.

5. The controller of claim 1, wherein the interface of the tethering device is an Ethernet interface, and the power manager refers to the cellular information to select the first tethering mode from a plurality of tethering modes, wherein the plurality of tethering modes comprise different combinations of cable types, low power mode settings, and/or transfer queue parameters for the Ethernet interface.

6. The controller of claim 1, wherein the power manager determines the first tethering mode whose corresponding bandwidth of the interface is lower than or closest to a cellular bandwidth of the tethering device from a plurality of tethering modes.

7. The controller of claim 1, wherein the power manager receives the cellular information and usage information of the tethering device, and determines the first tethering mode according to the cellular information and the usage information.

8. The controller of claim 7, wherein the usage information comprises network usage statistics indicating the flow of signal transmission/reception.

9. The controller of claim 1, wherein if the cellular information of the tethering device is updated, the power manager dynamically determines a second tethering mode according to the updated cellular information, and the tethering manager uses the second tethering mode to configure the at least one interface of the tethering device.

10. The controller of claim 9, wherein the power manager determines the second tethering mode whose corresponding bandwidth of the interface is lower than or closest to a cellular bandwidth of the tethering device from a plurality of tethering modes.

11. The controller of claim 9, wherein if the cellular information of the tethering device is updated, the power manager dynamically determines the second tethering mode according to the updated cellular information and usage information of the tethering device.

12. The controller of claim 9, wherein the usage information comprises network usage statistics indicating the flow of signal transmission/reception, and the power manager determines if a connection between the tethering device and the electronic device is able to be interrupted according to the usage information, for the determination of the second tethering device.

13. A control method of a tethering device, comprising:
receiving cellular information of the tethering device, and determining a first tethering mode according to the cellular information; and
using the first tethering mode to configure at least one interface of the tethering device, wherein the at least one interface of the tethering device is used to communicate with an electronic device, and the electronic device shares a cellular network of the tethering device via the at least one interface.

14. The control method of claim 13, wherein the cellular information comprises a radio access technology (RAT) currently used by the tethering device, a band currently used by the tethering device, and/or a real network speed of the tethering device.

15. The control method of claim 13, wherein the interface of the tethering device is a Wi-Fi interface, and the step of receiving the cellular information of the tethering device, and determining the first tethering mode according to the cellular information comprises:
referring to the cellular information to select the first tethering mode from a plurality of tethering modes, wherein the plurality of tethering modes comprise different combinations of antenna modes, bandwidths, and/or bands for the Wi-Fi interface.

16. The control method of claim 13, wherein the interface of the tethering device is an Universal Serial Bus (USB) interface, and the step of receiving the cellular information of the tethering device, and determining the first tethering mode according to the cellular information comprises:
referring to the cellular information to select the first tethering mode from a plurality of tethering modes, wherein the plurality of tethering modes comprise different combinations of connection types, speed modes, and/or transfer queue parameters for the USB interface.

17. The control method of claim 13, wherein the interface of the tethering device is an Ethernet interface, and the step of receiving the cellular information of the tethering device, and determining the first tethering mode according to the cellular information comprises:
referring to the cellular information to select the first tethering mode from a plurality of tethering modes, wherein the plurality of tethering modes comprise different combinations of cable types, low power mode settings, and/or transfer queue parameters for the Ethernet interface.

18. The control method of claim 13, wherein the step of receiving the cellular information of the tethering device, and determining the first tethering mode according to the cellular information comprises:
determining the first tethering mode whose corresponding bandwidth of the interface is lower than or closest to a cellular bandwidth of the tethering device from a plurality of tethering modes.

19. The control method of claim 13, wherein the step of receiving the cellular information of the tethering device, and determining the first tethering mode according to the cellular information comprises:
receiving the cellular information and usage information of the tethering device, and determining the first tethering mode according to the cellular information and the usage information.

20. The control method of claim 19, wherein the usage information comprises network usage statistics indicating the flow of signal transmission/reception.
